(19) United States
(12) Patent Application Publication
(10) Pub. No.: US 2026/0163284 A1
(43) Pub. Date: Jun. 11, 2026

(54) ELECTRICAL CONNECTOR

(71) Applicant: CHENG UEI PRECISION INDUSTRY CO., LTD., New Taipei City (TW)

(72) Inventors: JUN CHEN, Dong-Guan City (CN); ZHI-BIN DONG, Dong-Guan City (CN)

(21) Appl. No.: 19/194,537

(22) Filed: Apr. 30, 2025

(30) Foreign Application Priority Data
Oct. 17, 2024 (CN) 202422520043.4

(51) Int. Cl. H01R 13/405; H01R 13/6585

(52) U.S. Cl. CPC H01R 13/405; H01R 13/6585

(57) ABSTRACT

An electrical connector includes an insulating body, and a terminal assembly fixed in the insulating body. The insulating body has a covering end formed at a front end of the insulating body. The terminal assembly includes an insulating seat, a plurality of terminal slots recessed in two outer surfaces of the insulating seat, a plurality of conductive terminals received in the plurality of the terminal slots, a covering portion formed at a front end of the insulating seat, and a plurality of insertion slots. Each conductive terminal includes a contacting portion, and an insertion portion inserted in the insertion slot. An outer surface of the contacting portion is inclined forward and inward to form a chamfer. The insertion portion extends forward to form an extension portion extending out of the insertion slot. The covering end encloses the extension portions of the plurality of the conductive terminals.

### CROSS REFERENCE TO RELATED APPLICATIONS

The present application is based on, and claims priority from, China Patent Application No. 202422520043.4, filed Oct. 17, 2024, the disclosure of which is hereby incorporated by reference herein in its entirety.

### BACKGROUND OF THE INVENTION

### Field of the Invention

The present invention generally relates to an electrical connector, and more particularly

to an electrical connector having a better structural strength and preventing a terminal tilting.

### Description of Related Art

A USB (Universal Serial Bus) specification is a connector standard which is widely used in various electronic devices. With continuous variations of application scenarios, the USB specification has developed into specifications of USB 2.0, USB 3.0, Micro USB, Mini USB, and USB Type-C, etc. A USB Type-C connector has a function which is capable of charging and transmitting data, simultaneously. A positive surface and a reverse surface of a Type-C connector are insertable and withdrawal, so a usage convenience is improved, and the Type-C connector is the most widely used model currently.

Referring to FIG. 9, in order to enable the USB Type-C connector to be plugged and withdrawn in both orientations, the USB Type-C connector is equipped with a metal shell, a tongue piece disposed in the metal shell, and conductive terminals mounted to a positive surface and a reverse surface of the tongue piece. Traditionally, in order to install the conductive terminals to the positive surface and the reverse surface of the tongue piece, an insulating body is formed initially, then the conductive terminals are inserted to the insulating body, and the conductive terminals are assembled to the insulating body.

A conventional connector 100′ includes an insulating housing 10′, and a plurality of connecting terminals 20′ installed to the insulating housing 10′. The plurality of the connecting terminals 20′ are exposed to an upper surface and a lower surface of the insulating housing 10′, so that the conventional connector 100′ contact with a mating connector, and the conventional connector 100′ and the mating connector are mutually conductive. Nevertheless, in this structure design, when the plurality of the connecting terminals 20′ are in a process of being inserted into the insulating housing 10′ or when the conventional connector 100′ is inserted into a docking connector, front ends of the connecting terminals 20′ of the conventional connector 100′ tend to tilt. As a result, a lifespan is affected.

An electrical connector includes a base body, and an upper terminal assembly and a lower terminal assembly fixed in the base body. The upper terminal assembly includes a plurality of upper terminals and an upper body. Each upper terminal has an upper fixing portion and an upper contacting portion. The upper fixing portions of the plurality of the upper terminals are surrounded by the upper body, and the upper fixing portions of the plurality of the upper terminals are fixed in the upper body. The upper fixing portion extends forward to form the upper contacting portion exposed to a front end of the upper body. The lower terminal assembly includes a plurality of lower terminals and a lower body. Each lower terminal has a lower fixing portion and a lower contacting portion. The lower fixing portions of the plurality of the lower terminals are surrounded by the lower body, and the lower fixing portions of the plurality of the lower terminals are fixed in the lower body. The lower fixing portion extends forward to form the lower contacting portion exposed to a front end of the lower body. A front end of the base body is covered with a front base portion. The front base portion surrounds front ends of the upper contacting portions of the plurality of the upper terminals and front ends of the lower contacting portions of the plurality of the lower terminals to prevent the upper terminal assembly and the lower terminal assembly from tilting. However, in this structural design, the upper contacting portion is exposed out of the upper body and the lower contacting portion is exposed out of the lower body, so a retention force between the plurality of the upper terminals and the upper body is affected, and a retention force between the plurality of the lower terminals and the lower body is affected, consequently, relatively fragile structures of the plurality of the upper terminals and the plurality of the lower terminals are caused.

In view of the above shortcomings, it is essential to provide an electrical connector having a better structural strength and preventing a terminal tilting.

### BRIEF SUMMARY OF THE INVENTION

An object of the present invention is to provide an electrical connector, comprising: an insulating body having a covering end integrally formed at a front end of the insulating body; and a terminal assembly fixed in the insulating body, the terminal assembly having an insulating seat, a plurality of terminal slots recessed in two outer surfaces of the insulating seat, a plurality of conductive terminals received in the plurality of the terminal slots, a covering portion integrally formed at a front end of the insulating seat, and a plurality of insertion slots, a front end of each terminal slot slantwise extending forward and downward, and extending into an interior of the covering portion to form the insertion slot, a front end of each insertion slot penetrating forward through a front end surface of the covering portion, wherein each conductive terminal includes a fixing portion, a contacting portion, a chamfer, an insertion portion and an extension portion, the fixing portion is fixed inside the insulating seat, the contacting portion is extended forward from a front end of the fixing portion, outer surfaces of the contacting portions of the plurality of the conductive terminals are exposed to the two outer surfaces of the insulating seat, a front end of the outer surface of the contacting portion is inclined forward and inward to form the chamfer, the chamfers of the plurality of the conductive terminals are exposed out of the two outer surfaces of the insulating seat, the insertion portion is located in front of the chamfer, the insertion portion slantwise extends frontward and towards the interior of the covering portion, the insertion portion is inserted in the insertion slot, a front end of the insertion portion horizontally extends forward to form the extension portion, a rear end of the extension portion is fixed in the insertion slot, and a front end of the extension portion extends out of a front end of the insertion slot through the front end surface of the covering portion, the covering end encloses the extension portions of the plurality of the conductive terminals.

Another object of the present invention is to provide an electrical connector, comprising: an insulating body having a covering end integrally formed at a front end of the insulating body; and a terminal assembly fixed in the insulating body, the terminal assembly having an insulating seat, a plurality of terminal slots recessed in two outer surfaces of the insulating seat, a plurality of conductive terminals received in the plurality of the terminal slots, a covering portion integrally formed at a front end of the insulating seat, and a plurality of insertion slots, a front end of each terminal slot slantwise extending forward and downward, and extending into an interior of the covering portion to form the insertion slot, a front end of each insertion slot penetrating forward through a front end surface of the covering portion, wherein each conductive terminal has a fixing portion fixed inside the insulating seat, a contacting portion extended forward from a front end of the fixing portion, a chamfer, an insertion portion and an extension portion, outer surfaces of the contacting portions of the plurality of the conductive terminals are exposed to two outer surfaces of the insulating seat, a front end of the outer surface of the contacting portion is inclined forward and inward to form the chamfer, the chamfers of the plurality of the conductive terminals are exposed out of the two outer surfaces of the insulating seat, the insertion portion is located in front of the chamfer, the insertion portion slantwise extends frontward and towards the interior of the covering portion, the insertion portion is inserted in the insertion slot, a front end of the insertion portion horizontally extends forward to form the extension portion, a rear end of the extension portion is fixed in the insertion slot, and a front end of the extension portion extends out of a front end of the insertion slot through the front end surface of the covering portion, the covering end encloses the extension portions of the plurality of the conductive terminals, an upper surface and a lower surface of the covering end are flush with an upper surface and a lower surface of the covering portion.

Another object of the present invention is to provide an electrical connector, comprising: a plurality of upper conductive terminals and two upper grounding terminals being integrated in an upper seat by injection molding, front ends of the plurality of the upper conductive terminals being protruded from a front end surface of the upper seat; a plurality of lower conductive terminals and two lower grounding terminals being integrated in a lower seat by injection molding, front ends of the plurality of the lower conductive terminals being protruded from a front end surface of the lower seat; a middle plate being assembled between the upper seat with the plurality of the upper conductive terminals and the two upper grounding terminals, and the lower seat with the plurality of the lower conductive terminals and the two lower grounding terminals; two shielding plates being respectively positioned above the upper seat and positioned under the lower seat, the two shielding plates being soldered to the middle plate; wherein the upper seat with the plurality of the upper conductive terminals and the two upper grounding terminals, the lower seat with the plurality of the lower conductive terminals and the two lower grounding terminals, the middle plate and the two shielding plates are integrated in an insulating body by injection molding; and wherein the front ends of the plurality of the upper conductive terminals, the front ends of the plurality of the lower conductive terminals, front ends of the two upper grounding terminals, front ends of the two lower grounding terminals are fully embedded in a front end of the insulating body.

As described above, the electrical connector includes the insulating body, and the terminal assembly fixed within the insulating body, the terminal assembly includes the insulating seat, the plurality of the terminal slots recessed in the two outer surfaces of the insulating seat, and the plurality of the conductive terminals received in the plurality of the terminal slots. Furthermore, the covering portion is integrally formed at the front end of the insulating seat, the front end of each terminal slot slantwise extends forward and downward, and extends into the interior of the covering portion to form the insertion slot, the front end of the connecting portion of each conductive terminal slantwise extends forward and towards the interior of the covering portion of the insulating seat to form the insertion portion inserted in the insertion slot, the front end of the insertion portion horizontally extends forward to form the extension portion, the rear end of the extension portion is fixed in the insertion slot, the front end of the extension portion extends out of the front end of the insertion slot through the front end surface of the covering portion, the covering end of the insulating body encloses the extension portions of the plurality of the conductive terminals, the covering end is connected to the front end surface of the covering portion, and the upper surface and the lower surface of the covering end of the insulating body are flush with the upper surface and the lower surface of the covering portion, so that a retention force between the insulating seat and the plurality of the conductive terminals is enhanced to enhance a structural strength of the electrical connector, and front ends of the plurality of the conductive terminals are effectively prevented from tilting due to an affection of an external force. As a result, the electrical connector has a better structural strength and prevents the conductive terminal tilting.

### BRIEF DESCRIPTION OF THE DRAWINGS

The present invention will be apparent to those skilled in the art by reading the following description, with reference to the attached drawings, in which:

FIG. 1 is a perspective view of an electrical connector according to a preferred embodiment of the present invention;

FIG. 2 is a cross-sectional view of the electrical connector along a line I-I of FIG. 1;

FIG. 3 is an exploded view of the electrical connector according to the preferred embodiment of the present invention;

FIG. 4 is an exploded view of a middle plate and a terminal assembly of the electrical connector according to the preferred embodiment of the present invention;

FIG. 5 is another exploded view of the middle plate and the terminal assembly of the electrical connector according to the preferred embodiment of the present invention;

FIG. 6 is a partial exploded view of the terminal assembly of the electrical connector according to the preferred embodiment of the present invention;

FIG. 7 is an enlarged view of an encircled portion A of the electrical connector of FIG. 6;

FIG. 8 is a partial enlarged view of a conductive terminal of the electrical connector according to the preferred embodiment of the present invention; and

FIG. 9 is a perspective view of a conventional connector in prior art.

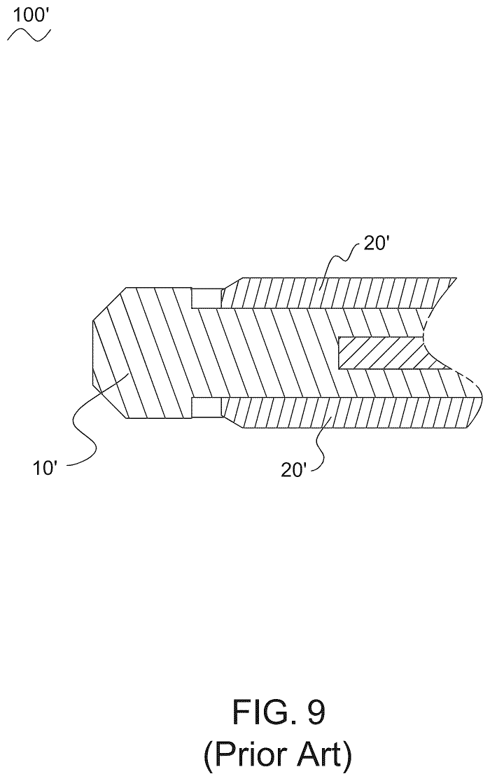

### DETAILED DESCRIPTION OF THE INVENTION

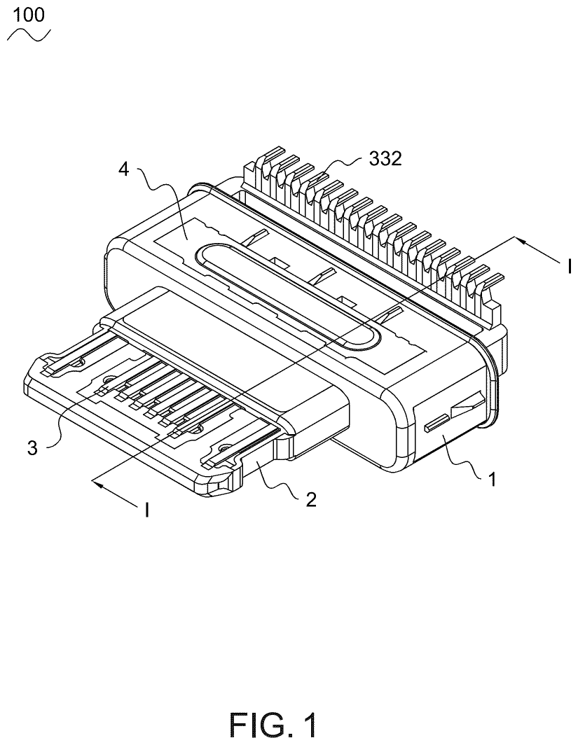

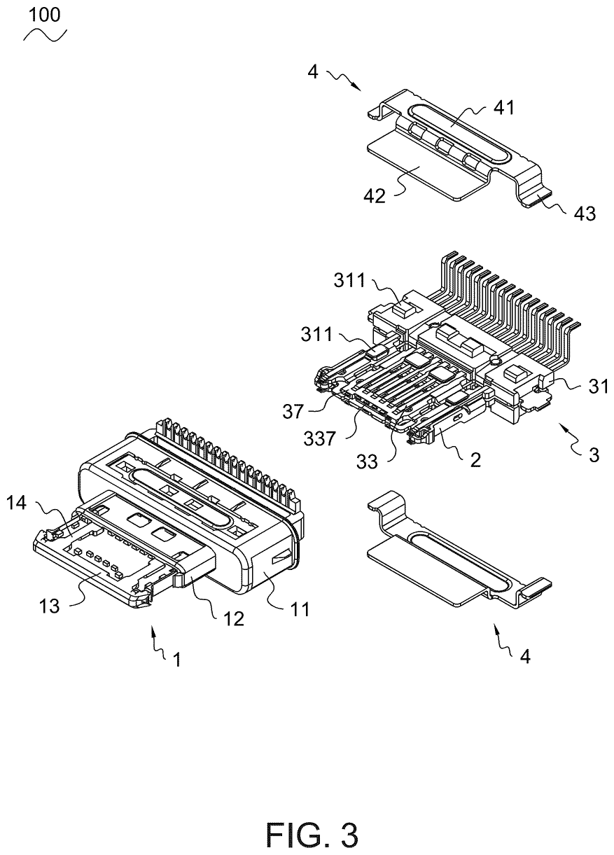

Referring to FIG. 1 and FIG. 3, an electrical connector 100 according to a preferred embodiment of the present invention is shown. The electrical connector 100 is exemplified by a USB (Universal Serial Bus) Type-C connector. The electrical connector 100 is used to be docked with a docking connector (not shown). The electrical connector 100 includes an insulating body 1, a middle plate 2, a terminal assembly 3 fixed in the insulating body 1, and two shielding plates 4. The insulating body 1 encases the middle plate 2, the terminal assembly 3 and the two shielding plates 4. The middle plate 2 is combined in a middle of the terminal assembly 3. The two shielding plates 4 are respectively assembled to an upper portion and a lower portion of the terminal assembly 3.

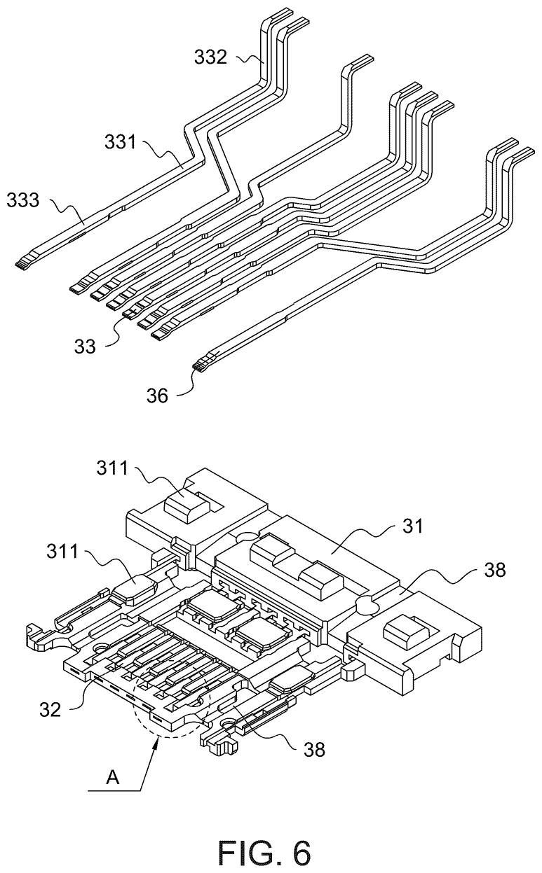

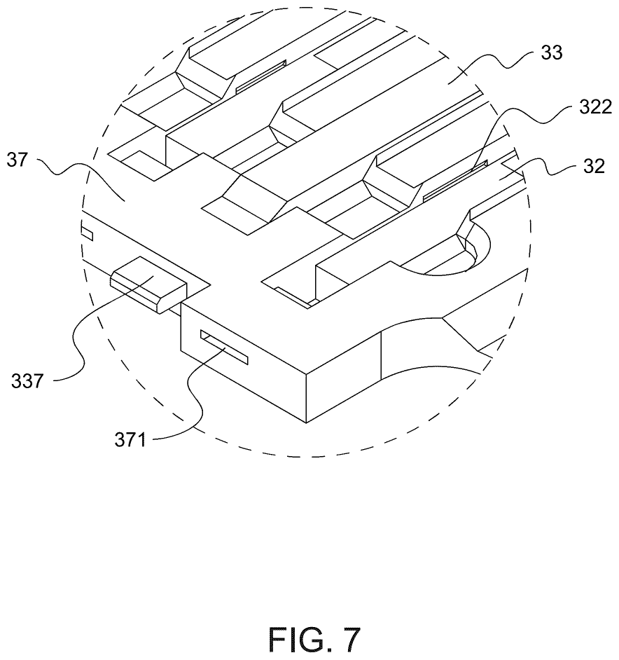

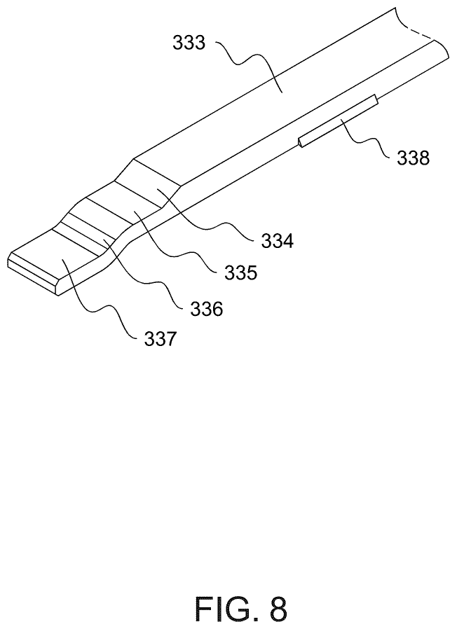

Referring to FIG. 3 to FIG. 8, the terminal assembly 3 includes an insulating seat 31, a plurality of terminal slots 32, a plurality of conductive terminals 33 and a covering portion 37. The plurality of the terminal slots 32 are recessed in two outer surfaces of the insulating seat 31, and the plurality of the terminal slots 32 are parallel. The plurality of the conductive terminals 33 are embedded in the insulating seat 31 by an injection molding technology, and the plurality of the conductive terminals 33 are received in the plurality of the terminal slots 32.

The covering portion 37 is integrally formed at a front end of the insulating seat 31. The covering portion 37 surrounds front ends of the plurality of the conductive terminals 33, and the front ends of the plurality of the conductive terminals 33 are fixed in the covering portion 37. The covering portion 37 has a plurality of insertion slots 371 extending to front ends of the plurality of the terminal slots 32. The plurality of the insertion slots 371 are communicated with the plurality of the terminal slots 32. A front end of each terminal slot 32 slantwise extends forward and downward, and extends into an interior of the covering portion 37 to form the curved insertion slot 371. A front end of each insertion slot 371 penetrates forward through a front end surface of the covering portion 37. The front ends of the plurality of the conductive terminals 33 are inserted into the plurality of the insertion slots 371, and the front ends of the plurality of the conductive terminals 33 protrude from the front ends of the plurality of the insertion slots 371 through the front end surface of the covering portion 37.

The insulating body 1 has a covering end 13 integrally formed at a front end of the insulating body 1. The covering end 13 is disposed to enclose the front ends of the plurality of the conductive terminals 33 which protrude from the front ends of the plurality of the insertion slots 371, and the front ends of the plurality of the conductive terminals 33 which protrude from the plurality of the insertion slots 371 are fixed in the covering end 13, so that the front ends of the plurality of the conductive terminals 33 are prevented from tilting. A lower portion of one side wall of each terminal slot 32 is recessed inward to form at least one notch 322. Two lower portions of two side walls of each terminal slot 32 are recessed oppositely to form two notches 322. The notches 322 of each terminal slot 32 are interlocked with one conductive terminal 33.

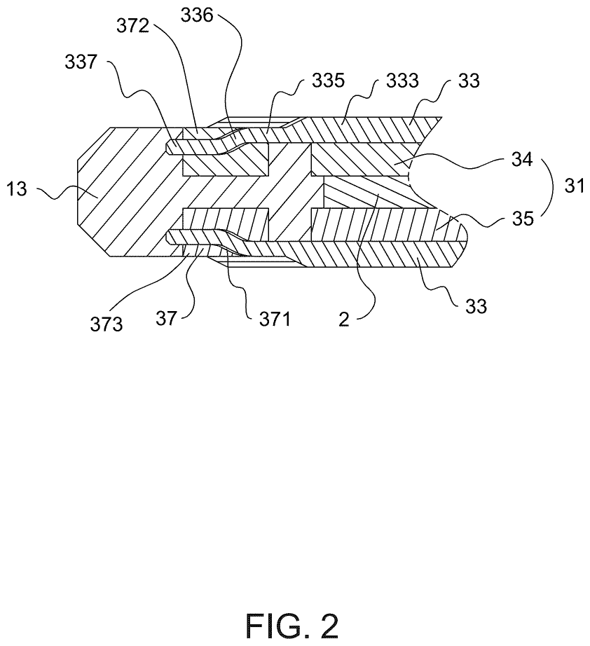

Referring to FIG. 2 to FIG. 8, each conductive terminal 33 includes a fixing portion 331, a soldering portion 332, a contacting portion 333, a chamfer 334, a connecting portion 335 extended forward from a front end of the chamfer 334, an insertion portion 336, an extension portion 337 and at least one latching portion 338. The fixing portion 331 is fixed inside the insulating seat 31. The soldering portion 332 is vertically extended upward and then is extended rearward from a rear end of the fixing portion 331. The soldering portion 332 is fixed in the insulating body 1. Tail ends of the soldering portions 332 of the plurality of the conductive terminals 33 extend out of the rear end of the insulating body 1 to be soldered onto a circuit board (not shown). The soldering portions 332 of the plurality of the conductive terminals 33 are transversely arranged in a row, and the soldering portions 332 of the plurality of the conductive terminals 33 are parallel.

The contacting portion 333 is extended forward from a front end of the fixing portion 331. Outer surfaces of the contacting portions 333 of the plurality of the conductive terminals 33 are exposed to two outer surfaces of the insulating seat 31. The contacting portions 333 of the plurality of the conductive terminals 33 are exposed to an upper surface and a lower surface of the insulating seat 31. An outer surface of the contacting portion 333 projects beyond a substantial middle of the outer surface of the insulating seat 31 to be electrically connected with the docking connector (not shown). A front end of the outer surface of the contacting portion 333 is inclined forward and inward to form the chamfer 334. The chamfers 334 of the plurality of the conductive terminals 33 are exposed out of the two outer surfaces of the insulating seat 31, so that the docking connector is guided by the chamfer 334 of each conductive terminal 33 of the electrical connector 100 to be docked with the electrical connector 100.

A front end of the chamfer 334 extends frontward to form the connecting portion 335. In this preferred embodiment, the connecting portion 335 is exposed to a front end of the outer surface of the insulating seat 31. An outer surface of the connecting portion 335 is flush with the front end of the outer surface of the insulating seat 31. In a specific implementation, the connecting portion 335 is surrounded by the insulating seat 31. The outer surface of the connecting portion 335 is exposed to the substantial middle of the outer surface of the insulating seat 31. The insertion portion 336 is formed at a front end of the connecting portion 335. The front end of the connecting portion 335 of each conductive terminal 33 slantwise extends forward and towards the interior of the covering portion 37 of the insulating seat 31 to form the insertion portion 336. The insertion portion 336 is located in front of the chamfer 334. The insertion portion 336 slantwise extends frontward and towards the interior of the covering portion 37. The insertion portion 336 is inserted in the insertion slot 371, so when the docking connector is docked with the electrical connector 100, the front ends of the plurality of the conductive terminals 33 are prevented tilting due to an affection of an external force.

A front end of the insertion portion 336 horizontally extends forward to form the extension portion 337. A rear end of the extension portion 337 is fixed in the insertion slot 371, and a front end of the extension portion 337 extends out of the front end of the insertion slot 371 through the front end surface of the covering portion 37. The covering end 13 of the insulating body 1 encloses the extension portions 337 of the plurality of the conductive terminals 33 to enhance a location and a fixation of the plurality of the conductive terminals 33, and the covering end 13 is connected to the front end surface of the covering portion 37. An upper surface and a lower surface of the covering end 13 of the insulating body 1 are flush with an upper surface and a lower surface of the covering portion 37. A side surface of the contacting portion 333 protrudes outward to form the at least one latching portion 338. Two side surfaces of the contacting portion 333 protrude outward to form two latching portions 338. The at least one latching portion 338 is interlocked with the at least one notch 322. The two latching portions 338 are interlocked with the two notches 322, so that a bonding force between the plurality of the conductive terminals 33 and the insulating seat 31 is enhanced.

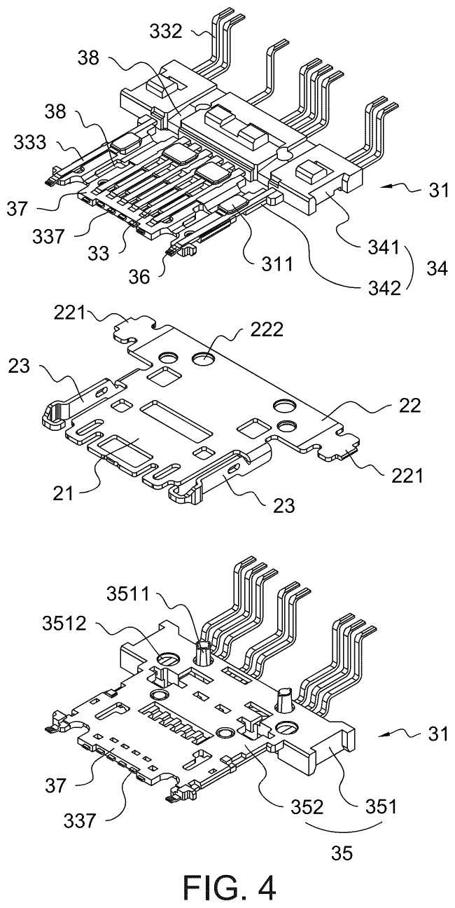

Referring to FIG. 4 to FIG. 6, the terminal assembly 3 includes two pairs of grounding terminals 36. The two pairs of the grounding terminals 36 are located to two sides of the plurality of the conductive terminals 33. Specifically, the pair of the grounding terminals 36 are located to a left side and a right side of the plurality of the conductive terminals 33. Structures of the pair of the grounding terminals 36 are substantially similar to the plurality of the conductive terminals 33. Each grounding terminal 36 has the contacting portion 333, the chamfer 334, the connecting portion 335, the insertion portion 336 and the extension portion 337. The contacting portion 333, the chamfer 334 and the connecting portion 335 of each grounding terminal 36 are exposed to the outer surface of the insulating seat 31.

Front ends of the grounding terminals 36 of the terminal assembly 3 extend out of the front end of the insulating seat 31. The front ends of the grounding terminals 36 of the terminal assembly 3 are surrounded by the covering end 13, and the front ends of the grounding terminals 36 of the terminal assembly 3 are fixed in the covering end 13. The insertion portion 336 and the extension portion 337 of each grounding terminal 36 extends out of the front end of the insulating seat 31. The insertion portion 336 and the extension portion 337 of each grounding terminal 36 are surrounded by the covering end 13, and the insertion portion 336 and the extension portion 337 of each grounding terminal 36 are fixed in the covering end 13 of the insulating body 1, so that front ends of the plurality of the grounding terminals 36 are prevented from tilting. In this preferred embodiment, a length of each grounding terminal 36 is greater than a length of each conductive terminal 33. The front end of the pair of the grounding terminals 36 extend beyond the front ends of the plurality of the conductive terminals 33.

Referring to FIG. 1 to FIG. 6, in this preferred embodiment, the insulating seat 31 includes an upper seat 34 and a lower seat 35. The upper seat 34 and the lower seat 35 have the plurality of the terminal slots 32, and the upper seat 34 and the lower seat 35 are equipped with the plurality of the conductive terminals 33 and the two pairs of the grounding terminals 36. The plurality of the conductive terminals 33 and the two pairs of the grounding terminals 36 are mounted to the upper seat 34 and the lower seat 35. The rear ends of the fixing portions 331 and the soldering portions 332 of the plurality of the conductive terminals 33 and the rear ends of the fixing portions 331 and the soldering portions 332 of the two pairs of the grounding terminals 36 are arranged in a row.

The front ends of the fixing portions 331 and the contacting portions 333 of the plurality of the conductive terminals 33 are vertically arranged into two rows. The front ends of the fixing portions 331 and the contacting portions 333 of one pair of the grounding terminals 36 are located to two sides of the front ends of the fixing portions 331 and the contacting portions 333 of one row of the conductive terminals 33. The front ends of the fixing portions 331 and the contacting portions 333 of the other pair of the grounding terminals 36 are located to two sides of the front ends of the fixing portions 331 and the contacting portions 333 of the other row of the conductive terminals 33.

The upper seat 34 includes an upper body 341, an upper tongue plate 342 and an upper covering portion 372. The upper tongue plate 342 is extended forward from a middle of a front end of the upper body 341. The upper covering portion 372 is formed at a front end of the upper tongue plate 342. The upper covering portion 372 surrounds the insertion portions 336 of the conductive terminals 33 which are mounted to the upper seat 34. The fixing portions 331 of the conductive terminals 33 and the grounding terminals 36 which are mounted to the upper seat 34 are fixed in the upper body 341 and the upper tongue plate 342. The contacting portions 333 of the conductive terminals 33 and the grounding terminals 36 which are mounted to the upper seat 34 are received in the upper tongue plate 342, and the top surfaces of the contacting portions 333 of the conductive terminals 33 and the grounding terminals 36 which are mounted to the upper seat 34 are exposed to an upper surface of the upper tongue plate 342 to be electrically connected with the docking connector. The soldering portions 332 of the conductive terminals 33 and the grounding terminals 36 which are mounted to the upper seat 34 are exposed to a rear end of the upper body 341.

The lower seat 35 is mounted under the upper seat 34. The lower seat 35 includes a lower body 351, a lower tongue plate 352 and a lower covering portion 373. The lower tongue plate 352 is extended forward from a middle of a front end of the lower body 351. The lower covering portion 373 is formed at a front end of the lower tongue plate 352. The lower covering portion 373 surrounds the insertion portions 336 of the conductive terminals 33 which are mounted to the lower seat 35. The lower body 351 is disposed corresponding to the upper body 341. The front end of the lower body 351 and the front end of the upper body 341 are aligned, and two sides of the lower body 351 and two sides of the upper body 341 are aligned. The lower tongue plate 352 is aligned with the upper tongue plate 342, and the lower covering portion 373 which is formed at the front end of the lower tongue plate 352 is aligned with the upper covering portion 372 which is formed at the front end of the upper tongue plate 342.

The fixing portions 331 of the conductive terminals 33 and the grounding terminals 36 which are mounted to the lower seat 35 are fixed in the lower body 351 and the lower tongue plate 352. The contacting portions 333 of the conductive terminals 33 and the grounding terminals 36 which are mounted to the lower seat 35 are received in the lower tongue plate 352, and bottom surfaces of the contacting portions 333 of the conductive terminals 33 and the grounding terminals 36 which are mounted to the lower seat 35 are exposed to a lower surface of the lower tongue plate 352 to be electrically connected with the docking connector. The soldering portions 332 of the conductive terminals 33 and the grounding terminals 36 which are mounted to the lower seat 35 are exposed to a rear end of the lower body 351. The soldering portions 332 of the upper seat 34 and the soldering portions 332 of the lower seat 35 are fixed to the rear end of the insulating body 1. The soldering portions 332 of the upper seat 34 and the soldering portions 332 of the lower seat 35 are interleaved, and the soldering portions 332 of the upper seat 34 and the soldering portions 332 of the lower seat 35 are transversely arranged in parallel. The soldering portions 332 of the upper seat 34 and the soldering portions 332 of the lower seat 35 are soldered onto the circuit board.

Referring to FIG. 4, the middle plate 2 is positioned between the upper seat 34 and the lower seat 35 to shield a signal interference. The middle plate 2 is made by stamping and bending a metal sheet. The middle plate 2 has a main board 21, an extension plate 22 and a pair of bending arms 23. The extension plate 22 is extended rearward and then extended outward from a rear end of the main board 21. Each side edge of the extension plate 22 protrudes outward to form a protrusion 221. The protrusion 221 is used to connect with a material strip (not shown). The pair of the bending arms 23 are vertically bent downward from two side edges of the main board 21, so that the middle plate 2 forms a three-dimensional structure to effectively enhance a lateral structural strength of the middle plate 2.

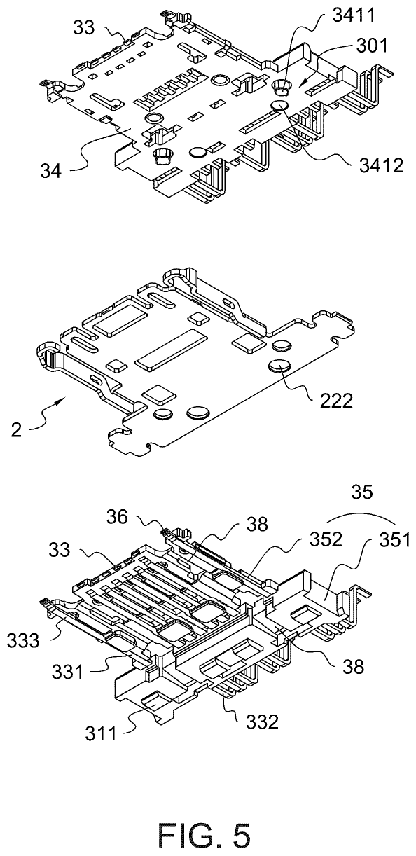

Referring to FIG. 4 and FIG. 5, in order to fix the middle plate 2 and the terminal assembly 3 in position, the middle plate 2 opens at least two positioning holes 222 at the extension plate 22. The insulating seat 31 of the terminal assembly 3 is equipped with a positioning structure 301 that is combined with the at least two positioning holes 222. In this preferred embodiment, the positioning structure has at least one positioning block 3411 protruded downward from a lower surface of the upper body 341, at least one through hole 3412 vertically penetrating through the upper body 341, at least one positioning post 3511 protruded upward from an upper surface of the lower body 351, and at least one recess 3512 recessed downward from the upper surface of the lower body 351. The at least one positioning block 3411 passes through one of the at least two positioning holes 222. The at least one positioning block 3411 and the one of the at least two positioning holes 222 are aligned with the recess 3512, and the at least one positioning block 3411 is combined with the at least one recess 3512. The at least one positioning post 3511 passes through the other one of the at least two positioning holes 222. The at least one positioning post 3511 and the other one of the at least two positioning holes 222 are aligned with the at least one through hole 3412, and the at least one positioning post 3511 is combined with the at least one through hole 3412.

Referring to FIG. 2 to FIG. 4, the insulating body 1 includes a main body 11, a tongue portion 12 and the covering end 13. The tongue portion 12 is extended forward from a middle of a front end of the main body 11. The tongue portion 12 is aligned with a middle of the insulating seat 31. The covering end 13 is integrally formed at a front end of the tongue portion 12. The main body 11 surrounds the upper body 341 and the lower body 351. The tongue portion 12 surrounds the upper tongue plate 342 and the lower tongue plate 352.

The fixing portion 331 is fixed in the main body 11 and the tongue portion 12. The contacting portion 333, the connecting portion 335 and the chamfer 334 are exposed out of an upper surface and a lower surface of the tongue portion 12. Specifically, the fixing portions 331 of the plurality of the conductive terminals 33 and the two pairs of the grounding terminals 36 are fixed in the main body 11 and the tongue portion 12. The contacting portions 333, the chamfers 334 and connecting portions 335 of the plurality of the conductive terminals 33 and the two pairs of the grounding terminals 36 are exposed out of the upper surface and the lower surface of the tongue portion 12. The extension portions 337 of the plurality of the conductive terminals 33 and the two pairs of the grounding terminals 36 are embedded into the covering end 13. The main board 21 is positioned between the upper tongue plate 342 and the lower tongue plate 352. The main board 21 is fixed in the tongue portion 12. The extension plate 22 is positioned between the upper body 341 and the lower body 351, and the extension plate 22 is fixed in the main body 11. The pair of the bending arms 23 are positioned to two fronts of two outer sides of the terminal assembly 3, and the pair of the bending arms 23 are fixed to two sides of the tongue portion 12.

Referring to FIG. 3, the two shielding plates 4 are disposed to reduce an electromagnetic interference. The two shielding plates 4 are respectively combined with an upper surface of the upper seat 34 and a lower surface of the lower seat 35. The two shielding plates 4 are mirror images. Each shielding plate 4 has a first plate portion 41, a second plate portion 42 and two fixing legs 43. The two first plate portions 41 and the two second plate portions 42 of the two shielding plates 4 are exposed to an upper surface and a lower surface of the insulating body 1. The two first plate portions 41 of the two shielding plates 4 are exposed to a top surface and a bottom surface of the main body 11. The second plate portion 42 is perpendicularly bent inward and then is extended forward from a middle of a front edge of the first plate portion 41. The second plate portions 42 of the two shielding plates 4 are exposed to the upper surface and the lower surface of the tongue portion 12. The two fixing legs 43 are perpendicularly bent inward and then are extended outward from two side edges of the first plate portion 41. The two fixing legs 43 are fixed within the main body 11 of the insulating body 1.

The first plate portions 41 of the two shielding plates 4 are respectively attached to an upper surface of the upper body 341 and a lower surface of the lower body 351. The second plate portions 42 of the two shielding plates 4 are respectively attached to the upper surface of the upper tongue plate 342 and the lower surface of the lower tongue plate 352. The two fixing legs 43 of the two shielding plates 4 are respectively positioned to both sides of the upper body 341 and both sides of the lower body 351. The two fixing legs 43 are positioned to an upper surface and a lower surface of the extension plate 22 of the middle plate 2, and the two fixing legs 43 are fixed to two sides of the upper surface and two sides of the lower surface of the extension plate 22 of the middle plate 2 by a spot soldering way, so that the two shielding plates 4 are located to the middle plate 2, and the two shielding plates 4 are fastened to the middle plate 2.

Rear ends of the two outer surfaces of the insulating seat 31 protrude outward to form at least two supporting blocks 311. The upper surface and the lower surface of the insulating seat 31 protrude outward to form the at least two supporting blocks 311. In this preferred embodiment, the at least two supporting blocks 311 are protruded outward from the upper surface of the upper seat 34 and the lower surface of the lower seat 35. The at least two supporting blocks 311 support the two shielding plates 4, so that encapsulation problems of the two shielding plates 4 are avoided during a formation process of the insulating body 1.

Referring to FIG. 1 to FIG. 8, during an assembly of the electrical connector 100, at first, the conductive terminals 33 are molded into the upper seat 34 and the lower seat 35 by an injection molding technology, at the moment, the insertion portions 336 of the plurality of the conductive terminals 33 are embedded into the plurality of the insertion slots 371. Next, the upper seat 34 and the lower seat 35 are respectively assembled to an upper surface and a lower surface of the middle plate 2. Then, the two shielding plates 4 are respectively assembled to the upper surface of the upper seat 34 and the lower surface of the lower seat 35, and the two shielding plates 4 are respectively fixed to the upper surface and the lower surface of the middle plate 2 by the spot soldering way. Finally, the insulating body 1 is molded to enclose the middle plate 2, the terminal assembly 3 and the two shielding plates 4 by a secondary embedded injection molding, at the moment, the extension portions 337 of the plurality of the conductive terminals 33 and the two pairs of the grounding terminals 36 are surrounded by the covering end 13, so the electrical connector 100 completes being assembled.

In this preferred embodiment, the insulating seat 31 has two pairs of channels 38. Two sides of the upper surface of the upper seat 34 are recessed inward to form one pair of the channels 38. Two sides of the lower surface of the lower seat 35 are recessed inward to form the other pair of the channels 38. The two channels 38 of the upper seat 34 are formed by being recessed in the upper surface of the upper body 341 and the upper surface of the upper tongue plate 342, and the other two channels 38 of the lower seat 35 are formed by being recessed in the lower surface of the lower body 351 and the lower surface of the lower tongue plate 352.

During a molding process of the insulating body 1, the channels 38 of the insulating seat 31 are filled with molten plastics for providing a better plastic flowing performance, a limiting function is performed after the molten plastics are solidified, and then a combination between the insulating seat 31 and the insulating body 1 is stabler. Each channel 38 of the upper seat 34 and the lower seat 35 is located between one grounding terminal 36 and the conductive terminal 33 adjacent to the one grounding terminal 36. The channel 38 of the upper seat 34 longitudinally extends from the upper tongue plate 342 to the upper body 341 and extends along an insertion direction of the electrical connector 100. The channel 38 of the lower seat 35 longitudinally extends from the lower tongue plate 352 to the lower body 351 and extends along the insertion direction of the electrical connector 100. The insulating body 1 has a plurality of insertion strips 14. The plurality of the insertion strips 14 are positioned to two sides of the upper surface and two sides of the lower surface of the insulating body 1. The plurality of the insertion strips 14 are embedded in the channels 38 of the insulating seat 31.

As described above, the electrical connector 100 includes the insulating body 1, and the terminal assembly 3 fixed within the insulating body 1, the terminal assembly 3 includes the insulating seat 31, the plurality of the terminal slots 32 recessed in the two outer surfaces of the insulating seat 31, and the plurality of the conductive terminals 33 received in the plurality of the terminal slots 32. Furthermore, the covering portion 37 is integrally formed at the front end of the insulating seat 31, the front end of each terminal slot 32 slantwise extends forward and downward, and extends into the interior of the covering portion 37 to form the insertion slot 371, the front end of the connecting portion 335 of each conductive terminal 33 slantwise extends forward and towards the interior of the covering portion 37 of the insulating seat 31 to form the insertion portion 336 inserted in the insertion slot 371, the front end of the insertion portion 336 horizontally extends forward to form the extension portion 337, the rear end of the extension portion 337 is fixed in the insertion slot 371, the front end of the extension portion 337 extends out of the front end of the insertion slot 371 through the front end surface of the covering portion 37, the covering end 13 of the insulating body 1 encloses the extension portions 337 of the plurality of the conductive terminals 33, the covering end 13 is connected to the front end surface of the covering portion 37, and the upper surface and the lower surface of the covering end 13 of the insulating body 1 are flush with the upper surface and the lower surface of the covering portion 37, so that a retention force between the insulating seat 31 and the plurality of the conductive terminals 33 is enhanced to enhance a structural strength of the electrical connector 100, and the front ends of the plurality of the conductive terminals 33 are effectively prevented from tilting due to the affection of the external force. As a result, the electrical connector 100 has a better structural strength and prevents the conductive terminal 33 tilting.

What is claimed is:

1. An electrical connector, comprising:
an insulating body having a covering end integrally formed at a front end of the insulating body; and
a terminal assembly fixed in the insulating body, the terminal assembly having an insulating seat, a plurality of terminal slots recessed in two outer surfaces of the insulating seat, a plurality of conductive terminals received in the plurality of the terminal slots, a covering portion integrally formed at a front end of the insulating seat, and a plurality of insertion slots, a front end of each terminal slot slantwise extending forward and downward, and extending into an interior of the covering portion to form the insertion slot, a front end of each insertion slot penetrating forward through a front end surface of the covering portion;
wherein each conductive terminal includes a fixing portion, a contacting portion, a chamfer, an insertion portion and an extension portion, the fixing portion is fixed inside the insulating seat, the contacting portion is extended forward from a front end of the fixing portion, outer surfaces of the contacting portions of the plurality of the conductive terminals are exposed to the two outer surfaces of the insulating seat, a front end of the outer surface of the contacting portion is inclined forward and inward to form the chamfer, the chamfers of the plurality of the conductive terminals are exposed out of the two outer surfaces of the insulating seat, the insertion portion is located in front of the chamfer, the insertion portion slantwise extends frontward and towards the interior of the covering portion, the insertion portion is inserted in the insertion slot, a front end of the insertion portion horizontally extends forward to form the extension portion, a rear end of the extension portion is fixed in the insertion slot, and a front end of the extension portion extends out of a front end of the insertion slot through the front end surface of the covering portion, the covering end encloses the extension portions of the plurality of the conductive terminals.

2. The electrical connector as claimed in claim 1, wherein each conductive terminal has a connecting portion, a front end of the chamfer extends frontward to form the connecting portion, the connecting portion is exposed to a front end of the outer surface of the insulating seat, an outer surface of the connecting portion is flush with the front end of the outer surface of the insulating seat, a front end of the connecting portion of each conductive terminal slantwise extends forward and towards the interior of the covering portion to form the insertion portion, the outer surface of the contacting portion projects beyond a middle of the outer surface of the insulating seat.

3. The electrical connector as claimed in claim 1, wherein each conductive terminal has a connecting portion extended forward from a front end of the chamfer, the connecting portion is surrounded by the insulating seat, and the insertion portion is formed at a front end of the connecting portion.

4. The electrical connector as claimed in claim 1, wherein the insulating body has a main body and a tongue portion, the tongue portion is extended forward from a middle of a front end of the main body, the tongue portion is aligned with a middle of the insulating seat, the covering end is integrally formed at a front end of the tongue portion, the fixing portion is fixed in the main body and the tongue portion, the contacting portion and the chamfer are exposed out of an upper surface and a lower surface of the tongue portion.

5. The electrical connector as claimed in claim 4, wherein the insulating seat has an upper seat and a lower seat, the upper seat has an upper body, an upper tongue plate and an upper covering portion, the upper tongue plate is extended forward from a middle of a front end of the upper body, the upper covering portion is formed at a front end of the upper tongue plate, the lower seat is mounted under the upper seat, the lower seat has a lower body, a lower tongue plate and a lower covering portion, the lower tongue plate is extended forward from a middle of a front end of the lower body, the lower covering portion is formed at a front end of the lower tongue plate, the front end of the lower body and the front end of the upper body are aligned, two sides of the lower body and two sides of the upper body are aligned, and the lower tongue plate is aligned with the upper tongue plate, the main body surrounds the upper body and the lower body, the tongue portion surrounds the upper tongue plate and the lower tongue plate.

6. The electrical connector as claimed in claim 5, wherein the insulating seat has two pairs of channels, two sides of an upper surface of the upper seat are recessed inward to form one pair of the channels, two sides of a lower surface of the lower seat are recessed inward to form the other pair of the channels, the two channels of the upper seat are formed by being recessed in an upper surface of the upper body and an upper surface of the upper tongue plate, and the other two channels of the lower seat are formed by being recessed in a lower surface of the lower body and a lower surface of the lower tongue plate, the insulating body has a plurality of insertion strips, the plurality of the insertion strips are embedded in the channels of the insulating seat.

7. The electrical connector as claimed in claim 6, wherein the terminal assembly has two pairs of grounding terminals, the two pairs of the grounding terminals are located to two sides of the plurality of the conductive terminals, front ends of the grounding terminals of the terminal assembly extend out of the front end of the insulating seat, the front ends of the grounding terminals of the terminal assembly are surrounded by the covering end, and the front ends of the grounding terminals of the terminal assembly are fixed in the covering end, each channel of the upper seat and the lower seat is located between one grounding terminal and the conductive terminal adjacent to the one grounding terminal.

8. The electrical connector as claimed in claim 1, wherein a lower portion of one side wall of each terminal slot is recessed inward to form at least one notch, a side surface of the contacting portion protrudes outward to form at least one latching portion, the at least one latching portion is interlocked with the at least one notch.

9. The electrical connector as claimed in claim 1, wherein a middle plate is located in the middle of the terminal assembly, two shielding plates are respectively assembled to an upper portion and a lower portion of the terminal assembly, an upper surface and a lower surface of the insulating seat protrudes outward to form at least two supporting blocks, the at least two supporting blocks support the two shielding plates, each shielding plate has a first plate portion, a second plate portion and two fixing legs, the second plate portion is perpendicularly bent inward and then is extended forward from a middle of a front edge of the first plate portion, the two first plate portions and the two second plate portions of the two shielding plates are exposed to an upper surface and a lower surface of the insulating body, the two fixing legs are perpendicularly bent inward and then are extended outward from two side edges of the first plate portion, the two fixing legs are fixed within the insulating body, the two fixing legs are positioned to the middle plate.

10. The electrical connector as claimed in claim 9, wherein the middle plate opens at least two positioning holes, the insulating seat is equipped with a positioning structure that is combined with the at least two positioning holes.

11. An electrical connector, comprising:
an insulating body having a covering end integrally formed at a front end of the insulating body; and
a terminal assembly fixed in the insulating body, the terminal assembly having:
an insulating seat;
a plurality of terminal slots recessed in two outer surfaces of the insulating seat;
a plurality of conductive terminals received in the plurality of the terminal slots;
a covering portion integrally formed at a front end of the insulating seat; and
a plurality of insertion slots, a front end of each terminal slot slantwise extending forward and downward, and extending into an interior of the covering portion to form the insertion slot, a front end of each insertion slot penetrating forward through a front end surface of the covering portion;
wherein each conductive terminal has a fixing portion fixed inside the insulating seat, a contacting portion extended forward from a front end of the fixing portion, a chamfer, an insertion portion and an extension portion, outer surfaces of the contacting portions of the plurality of the conductive terminals are exposed to two outer surfaces of the insulating seat, a front end of the outer surface of the contacting portion is inclined forward and inward to form the chamfer, the chamfers of the plurality of the conductive terminals are exposed out of the two outer surfaces of the insulating seat, the insertion portion is located in front of the chamfer, the insertion portion slantwise extends frontward and towards the interior of the covering portion, the insertion portion is inserted in the insertion slot, a front end of the insertion portion horizontally extends forward to form the extension portion, a rear end of the extension portion is fixed in the insertion slot, and a front end of the extension portion extends out of a front end of the insertion slot through the front end surface of the covering portion, the covering end encloses the extension portions of the plurality of the conductive terminals, an upper surface and a lower surface of the covering end are flush with an upper surface and a lower surface of the covering portion.

12. An electrical connector, comprising:
a plurality of upper conductive terminals and two upper grounding terminals being integrated in an upper seat by injection molding, front ends of the plurality of the upper conductive terminals being protruded from a front end surface of the upper seat;
a plurality of lower conductive terminals and two lower grounding terminals being integrated in a lower seat by injection molding, front ends of the plurality of the lower conductive terminals being protruded from a front end surface of the lower seat;
a middle plate being assembled between the upper seat with the plurality of the upper conductive terminals and the two upper grounding terminals, and the lower seat with the plurality of the lower conductive terminals and the two lower grounding terminals;
two shielding plates being respectively positioned above the upper seat and positioned under the lower seat, the two shielding plates being soldered to the middle plate;
wherein the upper seat with the plurality of the upper conductive terminals and the two upper grounding terminals, the lower seat with the plurality of the lower conductive terminals and the two lower grounding terminals, the middle plate and the two shielding plates are integrated in an insulating body by injection molding; and
wherein the front ends of the plurality of the upper conductive terminals, the front ends of the plurality of the lower conductive terminals, front ends of the two upper grounding terminals, front ends of the two lower grounding terminals are fully embedded in a front end of the insulating body.

13. The electrical connector as claimed in claim 12, wherein each of the upper seat and the lower seat has two channels, each channel of the upper seat is located between one upper grounding terminal and the plurality of the upper conductive terminals, each channel of the lower seat is located between one lower grounding terminal and the plurality of the lower conductive terminals, the insulating body has a plurality of insertion strips, the plurality of the insertion strips are embedded in the channels of the insulating seat.

14. The electrical connector as claimed in claim 13, wherein the channels and the plurality of the insertion strips are extended along an insertion direction of the electrical connector.
